(19) United States
(12) Patent Application Publication
(10) Pub. No.: US 2020/0253124 A1
(43) Pub. Date: Aug. 13, 2020

(54) CROP FLOW ASSISTANCE FOR HARVESTING HEADER

(71) Applicant: HONEY BEE MANUFACTURING LTD., Frontier (CA)

(72) Inventors: Glenn Raymond HONEY, Bracken (CA); Lee Glenn HARPER, Shaunavon (CA); Scott Douglas SMITH, Climax (CA)

(21) Appl. No.: 16/776,378

(22) Filed: Jan. 29, 2020

(30) Foreign Application Priority Data
Feb. 8, 2019 (CA) 3033499

(51) Int. Cl. A01D 57/20; A01D 41/14; A01D 33/04; A01D 63/04; A01D 57/01; A01D 61/00

(52) U.S. Cl. CPC A01D 57/20; A01D 41/14; A01D 61/008; A01D 63/04; A01D 57/01; A01D 33/04

(57) ABSTRACT

A harvesting header is disclosed that comprises a support frame and a crop moving apparatus supported on the support frame and operable for moving cut crop material to a transfer region. The header also has a cavity located proximate and lower than an output end of the crop moving apparatus. The header has a crop flow assistance device having a plurality of transversely spaced elements that extend generally longitudinally at least partially above the cavity, and which are operable to assist cut crop material in being transferred from the output end of the moving apparatus to flow over the cavity. The cavity may be operable to receive rocks and/or debris carried by the conveyor to the transfer region. The header may include a rock trap located in the transfer region the cavity being part of the rock trap and may be operable to receive rocks and/or debris carried by the conveyor to the transfer region.

### CROSS-REFERENCE TO RELATED APPLICATION

This application claims the foreign priority benefit of corresponding Canadian Patent Application Ser. No. 3,033,499 filed on Feb. 8, 2019. The entire contents of the aforementioned application are incorporated by reference herein.

### TECHNICAL FIELD

This relates to the field of agricultural machinery and equipment and in particular crop harvesting headers.

### BACKGROUND

The use of crop harvesting headers is known in the field of agriculture. Headers are used for a variety of purposes or applications, such as for example for use in harvesting crops with a header on a combine harvester or a header on a swather.

Harvesting equipment may be equipped with a header located generally at its front portion. The header may be generally oriented transverse to the direction of movement of the harvesting equipment during operation. The header may include a support frame, a cutting system to cut the portion of the crop that is to be harvested, a crop collection system having a surface or “table” onto which cut crop material can be collected and transported for further processing, and a rotating reel to assist in collecting and sweeping crop material onto the table.

To function effectively in cutting, collecting and transporting crop material to the intake of a combine harvester, it is desirable that crop that is cut by the cutting system, flows in a generally continuous, even flow pattern towards the intake of the combine harvester. If crop material does not flow evenly and continuously on the conveying apparatuses (e.g. a draper conveyor) then it can tend to form into a block (sometimes referred to as a “wad”) of crop material that can cause problems at the intake to the combine harvester. For example, a central infeed auger mounted transversely and located proximate the central intake area to a combine harvester can experience significant mechanical problems such as a slipping or disengaging of the clutch mechanism that links the drive mechanism to the auger, caused by uneven crop flow and wads of crop material being fed to the intake auger of the combine harvester. Thus, one design goal for a harvesting header is to create a fairly even continuous crop flow on the draper table as the crop is transported to the intake of the combine harvester.

Another somewhat related challenge which exists in the design and operation of a header for a combine harvester is that of rocks and/or other solid debris being picked up by the header from the ground surface as the combine harvester moves across a crop field as the crop is cut and crop material is moved onto the crop conveying apparatuses. As the crop is cut, the crop may move onto the one or more transversely oriented and moving conveyors along with rocks and/or other solid debris. The crop and rocks and/or debris may all be carried on the transverse conveyors to a central region where the input or intake of a longitudinally oriented feeder conveyor may be located. The longitudinally oriented, generally centrally located, feeder conveyor typically has the function of carrying the cut crop material rearward to the intake of a further crop processing apparatus associated with a typical combine harvester. Rocks/debris, depending on its size and shape, may cause damage to the longitudinal feeder conveyor which moves the cut crop from the header to the intake of the feeder housing of the combine harvester, particularly where such conveyors are of the auger type. Such rocks/debris may also damage the conveyor located in the feeder housing. Extremely severe damage may occur if a rock and/or other debris enters the further processing apparatus of a combine harvester. Additionally, rocks that are transported on the transverse conveyors may find their way into a pinch location between the outside edge at the end of the inward end of the transverse conveyor (where an end roller is typically located) and the support frame portion that supports the cutter bar assembly. This can cause jamming of the transverse conveyor and consequent damage thereto.

Rocks being transported with crop material also creates potential problems with swathers. Swathers don't have a center feed deck nor central feed auger, but instead have in the central table region a central opening through which cut crop material is deposited. The function of a swather is to cut the crop and then discharge the cut crop material in a way that builds a narrow crop windrow that is tall for optimal drying [i.e. swathers are typically used for cutting green crop, and allowing it to dry, before being collected and processed by a combine or baler, typically a few days after having been cut by the swather]. There can be a tendency with rocks being carried with cut crop material for the left and right transverse crop flow towards the central region to drop off the edge of the lateral decks, instead of staying in the middle area, due to crop flow interference with the crop entering the middle area that flow directly over the cutter bar. An effect called “hair pinning” can occur with the crop material in the middle region of the header, because it is typically taller than the cutter bar is deep. As such the crop material may tend to hang over the cutter bar, and so the crop stem may snap and create a holding effect on the unsupported crop behind the cutter bar. Thus it is desirable to also create a generally even, continuous crop flow pattern from the side draper into the central opening area and from the direction straight into the central opening area.

Various forms of rock/debris traps have been developed for combine harvesters (but not swathers), such as for example Applicant's own rock/debris trap apparatus as disclosed in U.S. Pat. No. 7,470,180 issued Dec. 30, 2008, the entire contents of which are hereby incorporated herein by reference.

However, at least some of the known rock trap systems have their own drawbacks. For example, some known rock traps have a cavity that may be in the range of about 4 to 6 inches in depth. When a transverse conveyor of a header moves cut crop material to the area of the rock trap, in addition to rocks and/or other debris falling into the cavity, some crop material may also fall into the cavity, instead of flowing from the transverse conveyor to the longitudinally oriented generally centrally located feeder conveyor. This crop material may then create a blockage of crop material, which may tend to build into a more solid portion block or wad of crop material. If a solid portion/wad of crop material does release from the vicinity of the rock/debris trap cavity, this can cause problems in the handling of this crop material in the longitudinal conveyor and/or the input to, and other areas of, the further processing unit of the combine harvester. Thus, the presence of a rock trap can itself be an impediment to creating a fairly even and continuous flow of crop material on the draper table and draper conveyors the central longitudinal conveyor and to the intake for the combine harvester.

Accordingly, it is desirable to improve the design and operation of headers combine harvesters and swathers and attempt to reduce one or more drawbacks associated with known rock traps and/headers.

### SUMMARY

According to one aspect of the invention there is provided a harvesting header that comprises a support frame. At least one crop moving apparatus supported on the support frame and operable for moving cut crop material to a transfer region. A cavity located proximate and lower than an output end of the at least crop moving apparatus. A crop flow assistance device having a plurality of transversely spaced elements that extend generally longitudinally at least partially above the cavity, the plurality of spaced elements operable to assist cut crop material in being transferred from the output end of the moving apparatus to flow over the cavity.

According to another aspect of the invention there is provided a harvesting header that comprises a support frame. At least one transverse conveyor on the support frame and operable for moving cut crop material to a transfer region. At least one longitudinal conveyor on the support frame and operable for moving cut crop material from the transfer region longitudinally rearward to a processing intake region. A rock trap located in the transfer region, the rock trap having a cavity located below an inward, output end of the at least one transverse conveyor, the cavity operable to receive rocks and/or debris carried by the transverse conveyor to the central region. A crop assistance flow device having a plurality of generally longitudinally extending, transversely spaced elements that extend above or partially into the cavity, the spaced elements operable to cause cut crop material transferred from the output end of the at least one conveyor to flow over the cavity and move onto the longitudinal conveyor and also operable to permit rocks and/or debris to pass the spaced elements to be received into the cavity.

According to another aspect of the invention there is provided a harvesting header that comprises a support frame. A crop moving apparatus supported on the support frame and operable for moving cut crop material to a transfer region. An anti-jamming device having a plurality of transversely spaced elements that extend generally longitudinally at least partially above or into the cavity, at least one element of the plurality of spaced elements being located at a laterally inward, longitudinally outside output end of the crop moving apparatus, the at least one element being operable to prevent rocks and/or debris from interfering in the operation of the crop moving apparatus.

According to another aspect of the invention there is provided a harvesting header that comprises a support frame. A crop moving apparatus supported on the support frame and operable for moving cut crop material to a transfer region. A rock deflecting device having a plurality of transversely spaced elements that extend generally longitudinally at least partially above or into the cavity, at least one element of the plurality of spaced elements being located at a laterally inward, longitudinally outside output end of the crop moving apparatus of the crop moving apparatus, the at least one element being operable to prevent rocks and/or debris from interfering in the operation of the crop moving apparatus.

According to another aspect of the invention there is provided a harvesting header that comprises a support frame. A crop moving apparatus supported on the support frame and operable for moving cut crop material to a transfer region. A rock deflecting device having a plurality of transversely spaced elements that extend generally longitudinally at least partially above or into the cavity, at least one element of the plurality of spaced elements being located at a laterally inward, longitudinally outside output end of the crop moving apparatus of the crop moving apparatus, the at least one element being operable to direct crop towards a central area of the transfer region.

### BRIEF DESCRIPTION OF THE DRAWINGS

In the figures which illustrate by way of example only embodiments:

FIG. 1 is a top plan view of a combine harvester with a header attached;

FIG. 1A is a partly disassembled view of the header of the combine harvester of FIG. 1;

FIG. 2 is top perspective view of a portion of the header of the combine harvester of FIG. 1, with some parts omitted for clarity;

FIG. 3 is a top perspective view of the central region of the header of FIG. 2 with additional parts omitted for clarity;

FIG. 4 is a bottom perspective view of the central region of the header depicted in FIG. 3;

FIG. 5 is a top plan view of the combine harvester of FIG. 1, illustrating cut crop material flow pathways;

FIG. 6 is top side perspective view of the central and left side regions of the header of FIG. 2;

FIG. 7 is a right side elevation view of the central and left side regions of the header of FIG. 2;

FIG. 7A is an enlarged view of the portion of FIG. 7 marked as 7A;

FIG. 8 is a top forward looking, perspective view of part of the central region of the header of FIG. 2; and

FIG. 9 is top, front, rearward looking perspective view of part of the central region of the header of FIG. 2.

### DETAILED DESCRIPTION

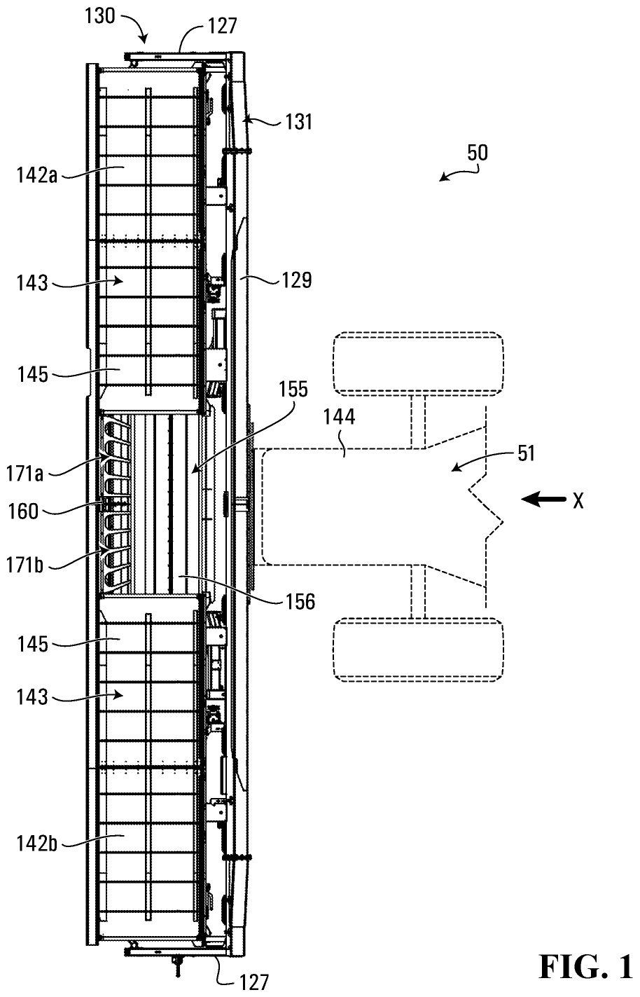

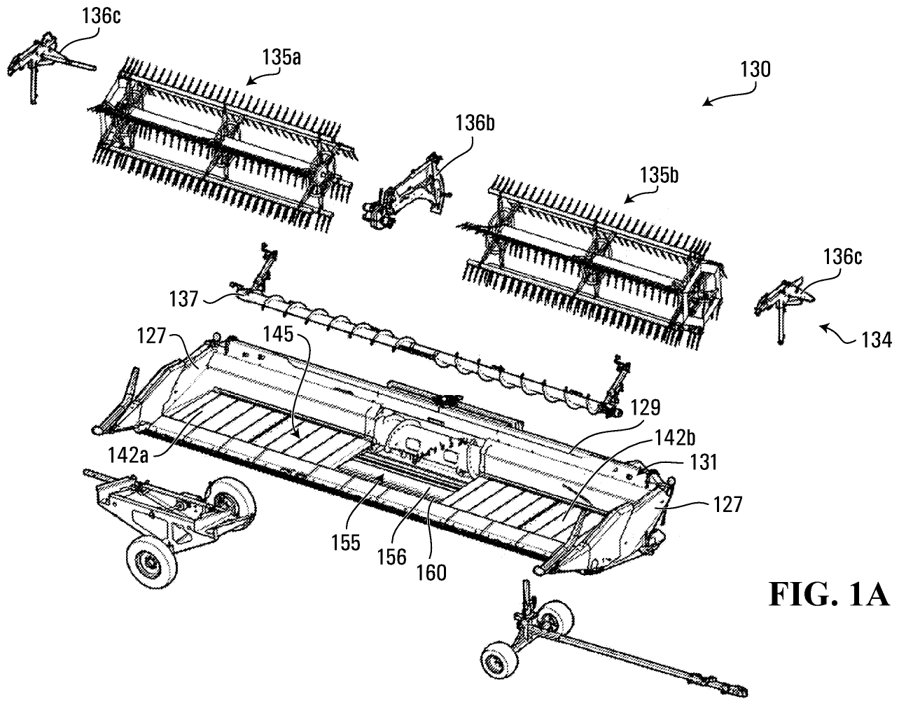

With reference initially to FIG. 1, a piece of agricultural harvesting equipment generally designated 50, in particular a combine harvester, is shown schematically. Combine harvester 50 may include a propulsion and processing portion 51 (hereinafter referred to as a “propulsion unit” 51 only a portion of which is shown schematically in FIG. 1) and a header 130. Propulsion unit 51 may include an operator cab (not shown) from which the operation of the combine harvester 50 and its components may be controlled. Propulsion unit 51 may be of a known type such as by way of example only, a combine harvester New Holland CR 9.90.

With reference now also to FIG. 1A, the various components of example header 130 are illustrated. Header 130 may be generally oriented transversely, and generally perpendicular to the direction of longitudinal direction X of movement of the combine harvester 50 when the combine harvester is moving through a field in an normal operating mode and configured to cut crops growing on the ground. Header 130 may include a support frame generally designated 131 that may include a transversely extending main frame tube or beam portion 129 extending between generally longitudinally oriented side frame members 127. Opposed side frame members 127 may extend and be interconnected to, and extend forward from, main frame tube 129 at each opposed end of main frame tube 129.

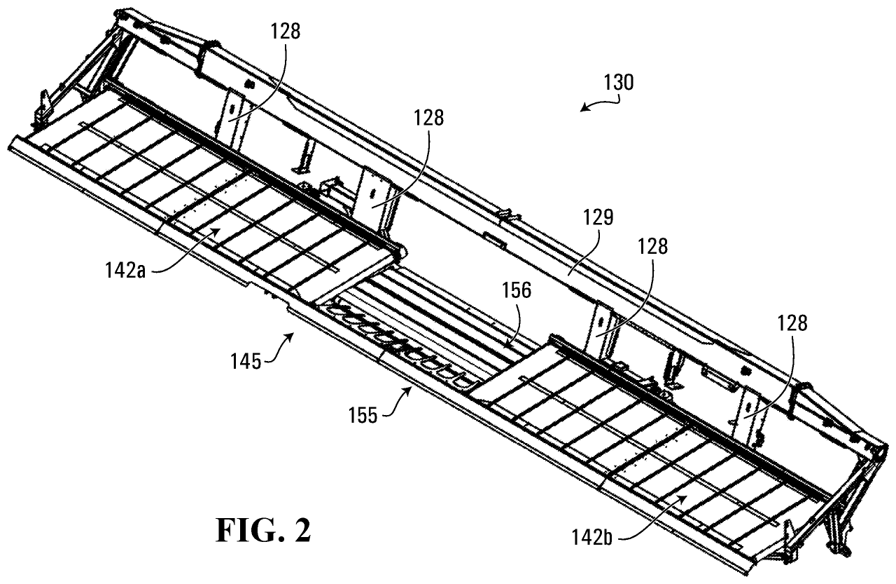

With reference also to FIG. 2, a plurality of transversely spaced, generally vertically oriented support struts 128 may extend downward from main frame tube 129 and may provide support for other components of header 130. Support frame 131 may be interconnected to and be supported on propulsion unit 51 of combine harvester 50. In some embodiments, support frame 131 may be translatable and rotatable in various directions relative to the propulsion unit 51 of the combine harvester 50.

Referring again to FIGS. 1, 1A, 2 and 5, header 130 may also include a conventional cuffing system 133 (often referred to as a “cutter bar”—and only shown in FIG. 1A for simplicity) that may be operable to cut the crop material that is to be harvested that is growing upwards from the ground surface. Header 130 may also include a reel apparatus 134 (only shown exploded away in FIG. 1A for simplicity) which may be operable to rotate and function to push the uncut crop material towards the cutter bar to be cut, and collect and sweep cut crop material onto an upward facing surface or “table” 145. Reel apparatus 134 may include two laterally aligned reel halves 135a, 135b, which may be mounted to frame support components on header 130 with reel arms 136a, 136b, 136c. A laterally extending cross auger 137 may also be mounted to frame support components of header 130 and be operable to assist in moving cut crop material laterally towards a central region 155 of the header.

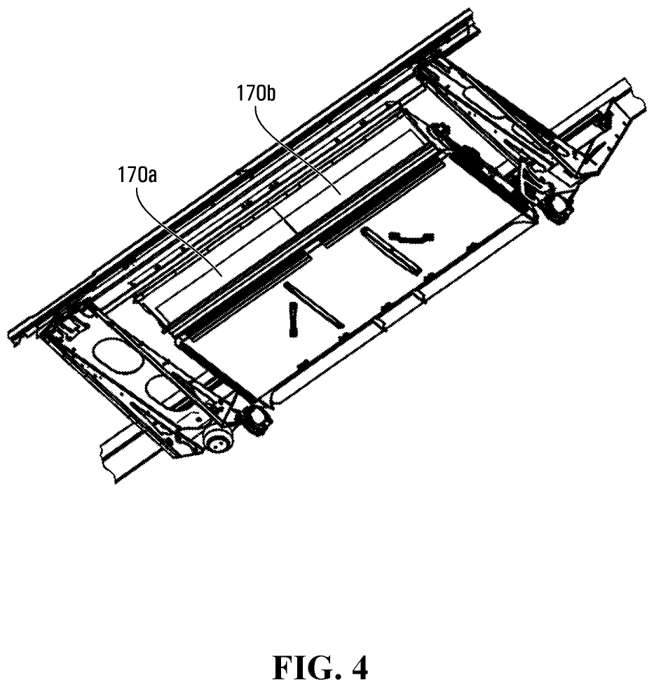

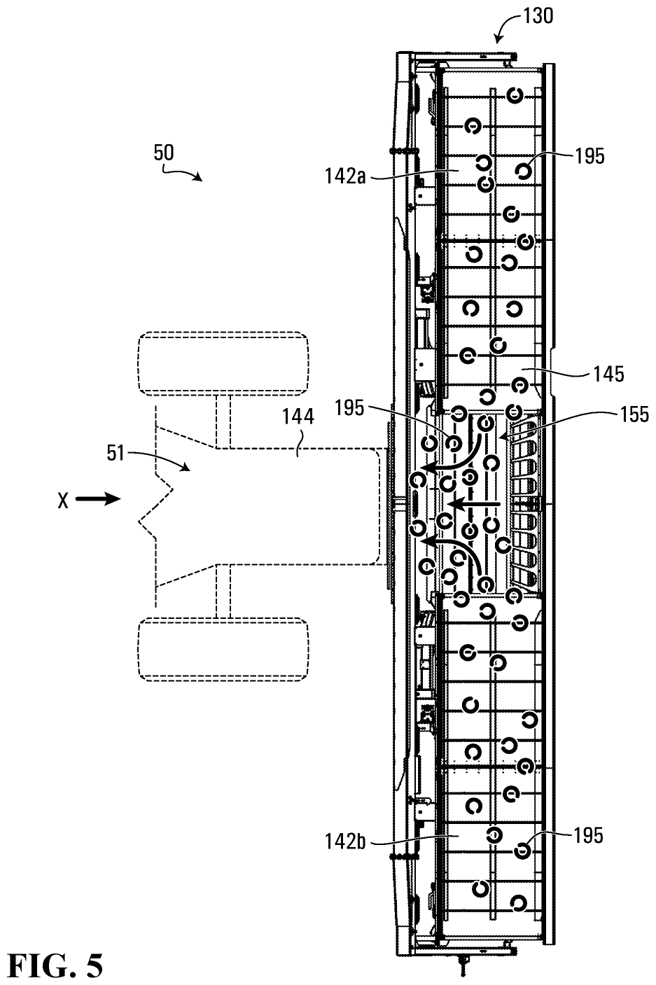

Header 130 may thus also include a crop collection system 143 that may include table 145 onto which cut crop material can be moved and collected. With reference still to FIGS. 1, 2 and 5, crop collection system 143 may also include one or more transversely oriented conveyors 142a, 142b (sometimes known as “drapers” or “draper conveyors”) associated with table 145 that can transport cut crop material 195 transversely inwards to central region 155 for further processing. In some embodiments, crop collection system 143 may include cross auger type conveyor 137 (FIG. 1A) adapted to assist in transporting crop material laterally for processing. In a typical combine harvester header 130 such as shown in FIGS.1, 1A, 2 and 5, there may be two transverse draper conveyors 142a, 142b, one located on either side of common central transfer region 155. Conveyors 142a, 142b may each transport cut crop material 195 transversely and inwardly to the common central transfer region 155 where the crop material may in some embodiments (not shown) simply be discharged from the header 130 (e.g. in a swather). However, in embodiments such as the embodiment of FIGS. 1-8, crop material 195 moved to central region 155 may be redirected longitudinally rearward as depicted in FIG. 5. Crop material 195 may thus be fed to the a feed auger 138 located proximate the intake/input 144 (FIG. 1) of the propulsion and processing unit 51 of combine harvester 50 for further processing by a longitudinally oriented conveyor 156 that normally during operation feeds cut crop material 195 rearward in a longitudinal direction.

Conveyor 156 may include one or more continuous belts that travel between a front idler roller and a rear drive roller. An hydraulic drive motor system may be provided for optionally permitting the direction of movement of the conveyor to be selectively moved in forward and reverse directions. Alternatively a mechanical belt drive mechanism may be provided which automatically reverses direction with the direction of the propulsion unit 51. In some such embodiments, the draper conveyors 142a, 142b, 156, the knife drive mechanism for the cutter bar 133 and the feed auger 138 may all automatically reverse in direction with a reverse in direction of propulsion unit 51. This may facilitate the relatively easy unplugging of crop material which has become stuck in such components.

Although only shown in FIG. 1A, there may be mounted in area 166 a transversely oriented, rotatable drum feed auger 138 that forms part of the crop material feeder system that feeds cut crop material delivered by conveyor 156 to the intake/input 144 to the further processing apparatus of combine harvester 50. Like the drum 54 disclosed in U.S. Pat. No 7,740,180, it may be driven by a separate hydraulic motor for rotation about a transverse axis. The drum may have rigid spiral auger flights, and additionally a plurality of retractable fingers projecting through a plurality of openings which are arranged spirally about the drum 54. The amount of projection of these fingers may be controlled by an internal camming system so that the fingers move to the most extended position on rotation of the drum as they approach the floor and start to retract to a withdrawn position as they approach the opening to the intake to the further processing apparatus. Accordingly, with such a drum, as the cut crop material is fed rearward in the central region 155, the crop can be quickly forced into the feeder house 22 of the attached combine unit 23.

Both the construction and operation of support frame 131, the cutting system and crop collection system 143 may be of types that are well known in the industry. Conveyors 142a, 142b and 156 may be driven and controlled by known types of conveyor drive systems.

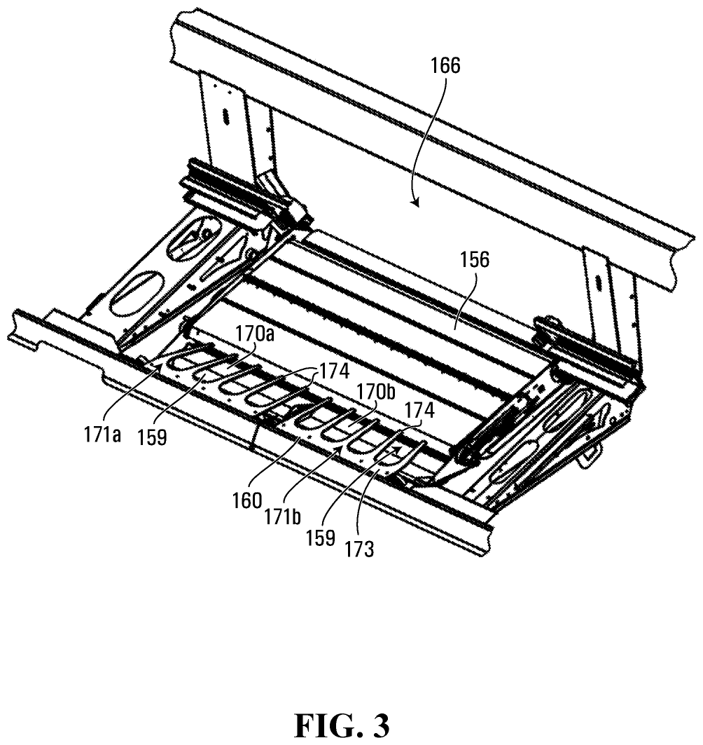

The central transfer region 155 of header 130 may be aligned with the intake/input 144 to the further processing apparatus (not shown) of combine harvester 50. The harvesting header 130 may have, in the area of central transfer region 155, located between the rearward edge of the cutter bar and the forward edge of the central longitudinal conveyor 156, and between the inward ends of transverse conveyors 142a, 142b, a rock and/or debris collecting area (also referred to as rock trap area or simply “rock trap”) generally designated 159. Rock trap 159 may be in the form of a cavity that is formed beneath the upper surfaces of transverse conveyors 142a, 142b and beneath the upper surface of longitudinal conveyor 156, and may be defined in part by generally upward facing planar surfaces of a pair of transversely oriented and positioned, trap doors 170a, 170b (see FIGS. 3, 4 and 7).

A trap door opening and closing system may be provided for opening and closing trap doors 170a, 170b. An example of a rock opening and closing system is disclosed in U.S. Pat. No. 7,470,180, the entire contents of which are hereby incorporated herein by reference. In header 130, as the rocks/debris are picked up by the header 130, and then dropped/transferred from the transversely travelling belts 142a, 142b to central longitudinal conveyor 156, they do not readily experience a quick transfer of direction rearward. Conveyor 156 may be slightly inclined forward such that crop material is moved slightly/generally vertically upward to the combine intake 144. Moreover, with this type of header and feeder adapter system there may be clear visibility from the operator's station of the rock trap area 159 and the rearward moving central conveyor 156. Once a rock has been detected by the operator, a control may be operated by an operator, or possibly automatically in response to a sensor detecting a rock/debris, to reverse the direction of the central conveyor 156. The trap doors 170a, 170b may be opened (also by an operator or automatically) whereby any rocks/debris that have moved into the rock trap area 159 can pass through the opened trap doors and fall away to the ground surface. When header 130 is in operating mode when cutting crop in a field, the floor of the rock trap 159 may be generally parallel to the ground, but may vary with header tilt angle [˜+/−5 degrees].

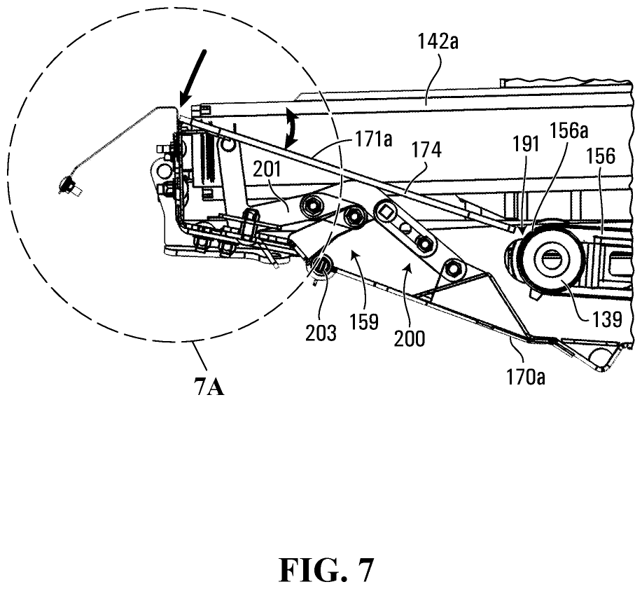

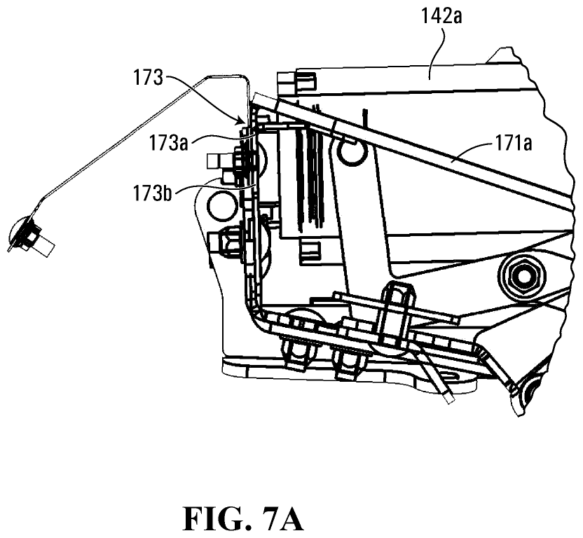

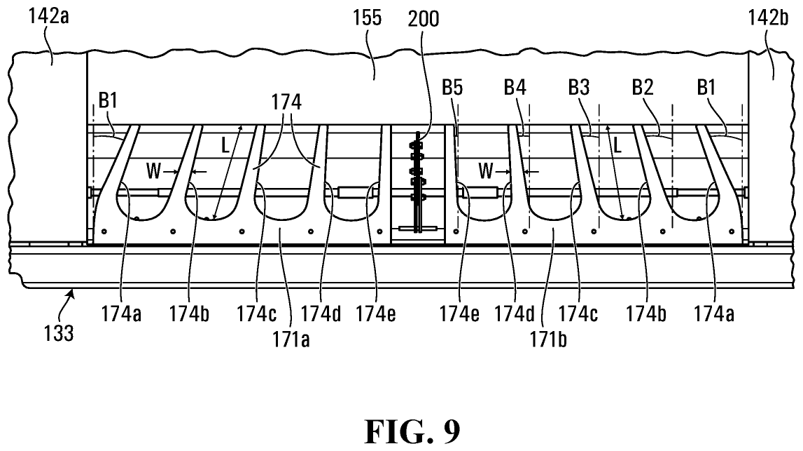

With particular reference to FIGS. 7A and 9, a door opening/closing mechanism generally designated as 200 may include a pivotable lever arm 201 that may pivot about pivot 203 to the extent required to move the trap door 170a between an open and closed (shown) position.

Positioned above the cavity defining rock trap area 159 is a crop flow assistance apparatus160 that may include an underlying, transversely extending base portion 173 (see FIG. 7A). Crop flow assistance apparatus 160 may also include two separate and spaced crop flow assistance devices 171a, 171b which may be transversely aligned and spaced transversely to each other. During operation of door opening/closing mechanism 200, the lever arm 201 of door opening/closing mechanism 200 is able to pivot between crop flow assistance devices as it is unobstructed by crop flow assistance devices 171a, 171b and base portion 173.

With particular reference to FIG. 9, crop flow assistance devices 171a, 171b may be pectinate (or comb-like) in shape—each having a transversely oriented base portion 176 and spaced, closely parallel tooth-like projections 174 that extend generally longitudinally rearward from base portion 176. Projections 174 may have generally flat upper surfaces over which crop material may travel. The projections 174 may be narrow enough that a typical rock cannot balance on their upper surface, and combined with deflection of the projections, causes the rock to drop into the cavity.

In some embodiments the projections may have upper surfaces that are arcuate downwards or otherwise sloped downwards. This may assist in having rocks that are passing over projections 174 not sit on top of the upper surfaces but instead move sideways. This movement of rocks off of the upper surfaces may be assisted by the general vibration of the header 130 during normal operation when cutting crops in a field. The spacing, choice of material and configuration of projections 174 may be such that most rocks encountered in a typical crop field will move to and fall between the projections 174. For larger rocks, the weight of the rocks may be such that typically the rocks will elastically deflect downwards (and possibly to some lesser extent sideways) one or more projections 174. In both cases, the rocks will pass into the cavity of the rock trap 150.

By way of example, for a rock trap cavity having a generally rectangular opening of a length of about 13 inches and a width of about 74 inches, projections 174 may have a length L about 10 inches long and an average width W about 1.5 inches wide. The projections 174 may be spaced apart with gaps of about 6 inches. It has been found that such a configuration will under conditions of the conveyors 142a, 142b moving about 450 ft/sec and conveyor 156 moving at about 550 ft./sec cut crop material 195 such as pulse [chick peas], cereals [wheat], and bushy crops [canola] may suitably flow from conveyors 142a, 142b onto conveyor 156 without significant blockages/crop wads from forming.

Transversely extending support base portion 173 may be made from a suitably strong material such as by way of example only 10 gauge bendable sheet metal and may be adapted to be secured to a portion of the frame of header 130. Base portion may be notched in central region 155 between the crop flow assistance devices 171a, 171b thus facilitating the unimpeded rotation of pivot arm 201 during operation of opening/closing mechanism 200 as referenced above.

The projections 174 may be integrally formed with base portion 176 from the same material. In other embodiments, projections 174 may be separate components that are attached to base portion 176. Projections 174 and base portion 176 may be made from a suitably strong, slippery, but elastically deformable material such as by way of example a hard plastic such as high density polyethylene (HDPE). Another example material that may be suitable is ultra-high molecular weight plastic.

Projections 174 and base portion 176 may be made from material(s) that when in sliding contact with a crop material, there are relatively low coefficients of static and kinetic friction between the upper surface of the projections/base portion and the crop material thus allowing the crop material; to relatively easily slide over top of the projections 174. The crop material will therefore tend to easily slide over the crop flow assistance devices 171a, 171b.

Smaller rocks/debris will tend to pass through the gaps between adjacent projections 174 to pass into the cavity of rock trap 159. Larger rocks will tend to deflect and elastically flex downwards projections 174 to allow the larger rocks/debris to pass into the cavity of rock trap 159.

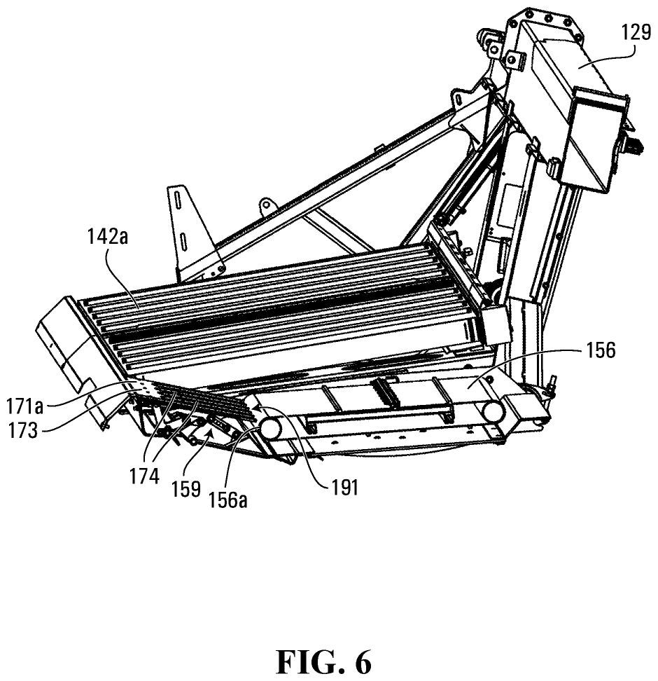

As best illustrated in FIGS. 6, 7, 7A, 8 and 9, crop flow assistance devices 171a, 171b may be mounted close to an upper edge area 196 of support base portion 173 that may be an angled metal bracket bent for example to about100 degrees [10 degrees past square] with mounting holes on one face/portion 173b (FIG. 7A) that line up with existing holes on the rear of the header structure between the draper decks. The other face/portion 173b of base 173 has holes that line up with the holes in the base 176 of crop flow assistance devices 171a, 171b. The intent is that the projections 174 of the devices are pointing approximately ⅓ down from the top of the center draper deck, approximately level with top surfaces of conveyors 142a, 142b. Projections may be angled downwards at an angle A in the range of about 0 to 10 degrees downward (FIG. 7A) from the upper surface plane of conveyors 142a, 142b.

A gap 191 may also be provided between the ends of projections 174 and the forward edge 156a (see FIGS. 6 and 7). This tends to reduce the risk of rocks/debris getting caught upon the ends of projections 174 and prevents or at least inhibits projections 174 from feeding rocks directly onto the draper table/central conveyor but instead will tend to flex down without interference from the center draper/conveyor 156 to drop off any rocks that may reach the end of the projections 174. As may be evident in FIG. 7, the tips of the projections 174 are generally pointing at a location above the center axis of the draper roller 139 of conveyor 156 but below the top front edge of the feed draper 156, with a gap 191 to allow fingers to deflect down unobstructed, if deflected by a heavy rock or to allow any crop material that has been fed or fell under conveyor 156 to return past projections 174 (which may also deflect upwards) to the top surface of conveyor 156.

The spaced tooth like projections 174 and base portion 176 function to create a flow path for crop material passing into central region 155 such that the crop material will tend to flow from laterally moving conveyors 142a, 142b through central region 155, onto central, rearward moving conveyor 156 with continuous movement, and without any significant amount of crop material dropping into the cavity of rock trap area 159. However, most rock and debris will be of a suitable size that they/it can pass through the spaces/gaps between projections 174 and/or through gap area 191, of the projections 174 will deflect downwards to allow the rocks to pass into the cavity of the rock trap 159.

As noted above, although not shown in FIGS. 1-8, there may be mounted in area 166 a rotatable drum auger feeder that forms part of the crop material feeder system that feeds cut crop material delivered by conveyor 156 to the intake/input 144 to the further processing apparatus of combine harvester 50. The drum may have rigid spiral auger flights, and additionally a plurality of retractable fingers projecting through a plurality of openings which are arranged spirally about the drum 54. With such a drum, as the cut crop material is fed rearward in the central region 155, the crop can be quickly forced into the feeder house 22 of the attached combine unit 23. It may be noted that by using crop flow assistance devices 171a, 171b, the risk of wads/blocks of cut crop material developing may be significantly reduced. The elimination or at least reduction in the formation of ‘wads’ being generated at the front of the center feeder deck/rock trap allows the feed auger 138 to receive a steady even flow crop to feed auger, thus optimizing performance of the header and combine, and minimizing peak loads on the feed auger drive [e.g. preventing the drive clutch from slipping].

It may be noted that the teeth like projections/members 174 and base 176 may in some embodiments be formed from any narrow (for projections 174), slippery semi rigid, elastic material. These members may be formed in such a manner that they are sufficiently rigid to permit crop material to flow over top, yet be sufficiently flexible to allow rocks to bend them so the rocks can pass into the rock track area. In some embodiments, these projections/members may be spring wire tines. Projection members made from steel may be used by not are preferred because they break off, and are ingested in the combine's processing area, significant potential damage can occur.

With crop flow assistance apparatus 170 installed over the cavity of rock trap 150, there is a significantly reduced tendency for the crop material being fed from the lateral conveyors and coming directly over the cutter bar assembly in front of the rock trap, to stall in the area of the rock track. The crop material will be more likely to flow over rock trap while still allowing any rocks and other heavy debris to pass into the cavity of the rock trap. With the crop flow assistance apparatus in place, the crop material being fed from the lateral/transverse conveyors, will tend to move into the center region of the longitudinal conveyor and merge with crop material from the opposite side lateral/transverse conveyor. Thus, the center portion of the longitudinal conveyor will tend to remain full with crop material and this provides more a more desirable flow pattern in terms of crop material being moved on the longitudinal conveyor to the intake of the combine harvester. The crop is aided in its flow to the center region of the feeder deck to promote center feeding, which is optimal for the combine.

With particular reference to FIGS. 6, 7, 7A, 8 and 9, other features of crop flow assistance devices 171a, 171b may be evident. First, it will be noted particularly from FIG. 9, that the inner most projections 174e on both crop flow assistance devices 171a, 171b are at an angle B5 that is zero or close to zero from the longitudinal direction. As one moves transversely outwards, the successive projections 174d, 174c, 174b and 174a, may be at respectively increasing angles B4, B3, B2 and B1 of 10, 20, 30 and 40 degrees respectively o the longitudinal direction.

Thus angle B5 of the outermost projection may be about 40 degrees from the straight longitudinal direction. This angling of projections 174a-d tends to also assist in creating an even, uninterrupted crop flow, tending to cause the crop material that comes from the lateral draper conveyors to pass over crop flow assistance devices 171a, 171b while merging into the middle of region 155 with crop material that is moving longitudinally straight onto the table over the cutter bar assembly 133.

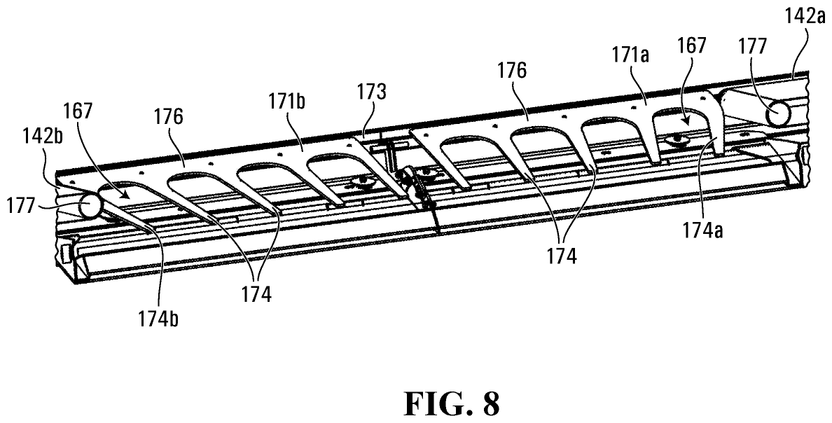

Another benefit associated with the installation of crop flow assistance devices 171a, 171b, in the location and orientation as particularly illustrated in FIG. 8, is the location and orientation of outermost projections 174a relative to the inner ends of the draper conveyors 142a, 142b and their respective inward rollers 177.

The presence of the projections 174a, and their base areas being at the same level or slightly higher than the end of the draper conveyors 142a, 142b, tends to block the penetration of small rocks at pinch locations 167 from jamming under lateral draper rollers 177 at front “pinch points”.

As referenced above, problems of rocks being transported with crop material also creates potential problems with swathers. Swathers don't have a center feed deck or feed auger, but as noted above, their function is to discharge the crop in a way that builds a narrow crop windrow that is tall for optimal drying [i.e. swathers are typically used for cutting green crop, and allowing it to dry, before being collected and processed by a combine or baler]. A crop flow assistance apparatus 160 may assist in meeting these swather requirements by: 1-allowing the crop on the lateral draper conveyors 142a, 142b to push further into the middle, aided by the increased crop flow from the crop flow apparatus [also observed on header]; and 2-by lofting the cut crop over the cutter bar and depositing the cut crop with the crop coming in from the sides. Because the mixing of center, left, and right crop flows will be closer to the middle of the swather head, the resulting windrow will be narrower and taller for a better drying.

The above described embodiments are intended to be illustrative only and in no way limiting. The described embodiments of carrying out the invention are susceptible to many modifications of form, arrangement of parts, details and order of operation. Other modifications will be apparent to those skilled in the art and, therefore, the invention is defined in the claims.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

1. A harvesting header comprising:
a support frame;
at least one crop moving apparatus supported on said support frame and operable for moving cut crop material to a transfer region;
a cavity located proximate and lower than an output end of said at least crop moving apparatus;
a crop flow assistance device having a plurality of transversely spaced elements that extend generally longitudinally at least partially above said cavity, said plurality of spaced elements operable to assist cut crop material in being transferred from said output end of said moving apparatus to flow over said cavity.

2. A harvesting header as claimed in claim 1 wherein said crop assistance flow device is positioned proximate an output end of said at least one crop moving apparatus such that in operation cut crop material will flow from said output end over said crop flow assistance device.

3. A harvesting header as claimed in claims 1 or claim 2 wherein:
said cavity is operable to receive rocks and/or debris carried by said at least one conveyor to said transfer region;
said header further comprises a rock trap located in said transfer region, said cavity being part of said rock trap and said cavity located at an end of said at least crop moving apparatus and operable to receive rocks and/or debris carried by said at least one conveyor to said transfer region; and
wherein said spaced elements are also operable to permit rocks and/or debris to pass said spaced elements to be received into said cavity; and wherein the elements are narrow enough that a rock cannot balance on an element, and combined with deflection of the element, cause said rock to drop into the cavity.

4. A harvesting header as claimed in claim 3 wherein said plurality of spaced elements are selected to be able to resist deflection when crop material is passing on top of said spaced elements.

5. A harvesting header as claimed in claim 4, wherein said plurality of spaced elements are selected to be able to be elastically deflected when rock material is on top of said spaced elements and thus said spaced elements are operable to deflect to allow said rock material to pass by said spaced elements and enter said cavity.

6. A harvesting header as claimed in claim 5, wherein the spaced elements are made from an elastically deflectable material.

7. A harvesting header as claimed in claim 6, wherein the spaced elements are made from a plastic material that is operable to permit crop material to slide over top of an upper surface of said spaced elements.

8. A harvesting header as claimed in claim 7 wherein said plastic material is high density polyethylene.

9. A harvesting header as claimed in claim 7 wherein said plastic material is ultra-high molecular weight plastic.

10. A harvesting header as claimed in any one of claims claim 1 wherein said plurality of projections are arranged in a pectinate shape.

11. A harvesting header as claimed in claim 10 wherein at least some of said plurality of projections are oriented at an angle to a longitudinal direction.

12. A harvesting header as claimed in claim 11 wherein each of said projections of said plurality of projections are oriented at inwardly directed angles to a longitudinal direction that gradually increase for projections the further away each projection is transversely positioned from a central region of said header.

13. A harvesting header as claimed in any one of claims claim 1 wherein said moving apparatus is a draper conveyor.

14. A harvesting header as claimed in any one of claims claim 1, wherein said at least one crop moving apparatus comprises:
a lateral moving conveyor operable for transporting cut crop material laterally to a central region of said header;
a longitudinal moving conveyor operable for transporting cut crop material longitudinally away from said central region of said header towards an intake of a combine harvester.

15. A harvesting header as claimed in claim 14 wherein said plurality of projections have tips wherein the tips of the projections are generally pointing at a location above the center axis of an end roller of said longitudinal moving conveyor and are pointing below the top front edge of the upper moving surface of the longitudinal moving conveyor.

16. A harvesting header as claimed in claim 14 further comprising a transversely oriented feed auger located proximate an output end of said longitudinal moving conveyor and operable to assist in feeding cut crop material to said intake of said combine harvester.

17. A harvesting header as claimed in claim 1 wherein said cavity has a permanent opening operable to allow crop material to be deposited in a windrow below said header.

18. A harvesting header as claimed in claim 1 wherein said cavity is part of a rock trap having a door operable to be opened, and to be closed to close a bottom opening in said cavity.

19. A harvesting header as claimed in claim 1 wherein said spaced elements are configured sufficiently narrowly such that rocks will not stay balanced on a top surface of said spaced elements.

20. A harvesting header as claimed in claim 19 wherein upper surfaces of said spaced elements are configured in such a shape that rocks will not stay balanced on a top surface of said spaced elements.

21. A harvesting header as claimed in claim 20, wherein such spaced elements being elastically deflectable by rocks, such spaced elements are operable such that rocks will pass said spaced elements and drop into the cavity.

22. A harvesting header comprising:
a support frame;
at least one transverse conveyor on said support frame and operable for moving cut crop material to a transfer region;
at least one longitudinal conveyor on said support frame and operable for moving cut crop material from said transfer region longitudinally rearward to a processing intake region;
a rock trap located in said transfer region, said rock trap having a cavity located below an inward, output end of said at least one transverse conveyor, said cavity operable to receive rocks and/or debris carried by said transverse conveyor to said central region;
a crop assistance flow device having a plurality of generally longitudinally extending, transversely spaced elements that extend above or partially into said cavity, said spaced elements operable to cause cut crop material transferred from said output end of said at least one conveyor to flow over said cavity and move onto said longitudinal conveyor and also operable to permit rocks and/or debris to pass said spaced elements to be received into said cavity.

23. A header as claimed in claim 22 wherein said header further comprises a transversely oriented feeding auger located at a discharge end of said longitudinal conveyor, said feeding auger operable to feed an intake of a combine harvester.

24. An agricultural equipment apparatus comprising:
(i) a propulsion unit;
(ii) a header as claimed in claim 1.

25. A harvesting header comprising:
a support frame;
a crop moving apparatus supported on said support frame and operable for moving cut crop material to a transfer region;
an anti-jamming device having a plurality of transversely spaced elements that extend generally longitudinally at least partially above or into said cavity, at least one element of said plurality of spaced elements being located at a laterally inward, longitudinally outside output end of said crop moving apparatus, said at least one element being operable to prevent rocks and/or debris from interfering in the operation of said crop moving apparatus.

26. A harvesting header as claimed in claim 25, wherein said at least one element of said plurality of spaced elements located at a laterally inward, longitudinally outside output end of said crop moving apparatus, is angled longitudinally inwards toward a central area of said transfer region.

27. A harvesting header as claimed in claim 26, wherein said at least one element of said plurality of spaced elements has a base portion that is located in close proximity to a roller at said output end of said crop moving apparatus.

28. A harvesting header as claimed in claim 25 wherein said base portion is located above an upper surface of said crop moving apparatus at said output end of said crop moving apparatus.

29. A harvesting header comprising:
a support frame;
a crop moving apparatus supported on said support frame and operable for moving cut crop material to a transfer region;
a rock deflecting device having a plurality of transversely spaced elements that extend generally longitudinally at least partially above or into a cavity, at least one element of said plurality of spaced elements being located at a laterally inward, longitudinally outside output end of said crop moving apparatus of said crop moving apparatus, said at least one element being operable to prevent rocks and/or debris from interfering in the operation of said crop moving apparatus.

30. A harvesting header comprising:
a support frame;
a crop moving apparatus supported on said support frame and operable for moving cut crop material to a transfer region;
a rock deflecting device having a plurality of transversely spaced elements that extend generally longitudinally at least partially above or into a cavity, at least one element of said plurality of spaced elements being located at a laterally inward, longitudinally outside output end of said crop moving apparatus of said crop moving apparatus, said at least one element being operable to direct crop towards a central area of said transfer region.
